(19) United States
(12) Patent Application Publication
(10) Pub. No.: US 2023/0222588 A1
(43) Pub. Date: Jul. 13, 2023

(54) ENERGY TRADING METHOD, INFORMATION PROCESSING APPARATUS, AND ENERGY TRADING SYSTEM

(71) Applicant: TOYOTA JIDOSHA KABUSHIKI KAISHA, Aichi-ken (JP)

(72) Inventors: Daigo KITTAKA, Yokohama-shi (JP); Hiroshi OKI, Seto-shi (JP); Masashi NAKAMURA, Toyota-shi (JP)

(73) Assignee: TOYOTA JIDOSHA KABUSHIKI KAISHA, Aichi-ken (JP)

(21) Appl. No.: 18/151,230

(22) Filed: Jan. 6, 2023

(30) Foreign Application Priority Data
Jan. 11, 2022 (JP) 2022-002635

(51) Int. Cl. G06Q 40/04; G06Q 30/0201; G06Q 50/06

(52) U.S. Cl. CPC G06Q 40/04; G06Q 30/0206; G06Q 50/06

(57) ABSTRACT

An energy trading method according to the present disclosure is an energy trading method to be performed by an information processing apparatus. The information processing apparatus acquires first information including planned values of a hydrogen purchase amount and a hydrogen purchase unit price from a first energy management system that manages an energy resource in a managed area. The information processing apparatus acquires second information including planned values of a hydrogen sale amount and a hydrogen sale unit price from a second energy management system that manages a hydrogen production facility. The information processing apparatus determines a supply amount and a unit price of hydrogen to be supplied from the hydrogen production facility to the energy resource based on the first information and the second information.

### CROSS-REFERENCE TO RELATED APPLICATION

This application claims priority to Japanese Patent Application No. 2022-002635, filed on Jan. 11, 2022, the entire contents of which are incorporated herein by reference.

### TECHNICAL FIELD

The present disclosure relates to an energy trading method, an information processing apparatus, and an energy trading system.

### BACKGROUND

The concept of a community Energy Management System (EMS) is being developed to manage power generation facilities, such as solar and wind power, distributed throughout a city or region, along with the electricity supply from an external power grid and the electricity demand occurring within the city or region, as a whole. To supply hydrogen primarily to fuel cell electric vehicles (FCEVs), hydrogen stations that produce hydrogen using solar energy or electricity provided by the power grid are being installed.

The electricity supply and electricity demand in a community, such as a city or region, and the amount of hydrogen produced at hydrogen stations fluctuate due to various factors, including weather conditions. This can result in temporary surpluses or shortages of electricity in the community and temporary surpluses or shortages of hydrogen produced at the hydrogen stations. Therefore, surplus electricity is charged into and discharged from storage batteries, and surplus hydrogen is stored in and released from storage facilities. A system has also been proposed to supply hydrogen from a nearby hydrogen station when the electricity supplied by a community's power generation facilities is insufficient. For example, see Patent Literature (PTL) 1. The hydrogen provided by a hydrogen station can be converted to electricity by fuel cells in the community. In this way, renewable energy such as solar and wind power, in particular, can be effectively used, and the amount of electricity purchased from external sources can be reduced.

### CITATION LIST

### Patent Literature

PTL 1: JP 2021-192570 A

### SUMMARY

In the proposed method, however, when hydrogen is transferred between energy resources in a community and a hydrogen station, the energy resources in the community and the hydrogen station are managed by the same EMS. Therefore, known methods merely provide instructions for hydrogen to be provided from a hydrogen station in a case in which energy is insufficient in a community. Known methods cannot be applied to the transfer of hydrogen between energy resources in a community and a nearby hydrogen station when these are operated and managed by different entities.

It would be helpful to effectively use energy by coordinating the supply amount and the supply price of hydrogen between independently operated and managed hydrogen stations and communities such as cities or regions.

An energy trading method according to an embodiment of the present disclosure is an energy trading method to be performed by an information processing apparatus. This method includes:
acquiring first information including planned values of a hydrogen purchase amount and a hydrogen purchase unit price from a first energy management system that manages an energy resource in a managed area;
acquiring second information including planned values of a hydrogen sale amount and a hydrogen sale unit price from a second energy management system that manages a hydrogen production facility; and
determining a supply amount and a unit price of hydrogen to be supplied from the hydrogen production facility to the energy resource based on the first information and the second information.

An information processing apparatus according to an embodiment of the present disclosure includes a first acquisition interface, a second acquisition interface, and a controller. The first acquisition interface is configured to acquire first information including planned values of a hydrogen purchase amount and a hydrogen purchase unit price from a first energy management system that manages an energy resource in a managed area. The second acquisition interface is configured to acquire second information including planned values of a hydrogen sale amount and a hydrogen sale unit price from a second energy management system that manages a hydrogen production facility. The controller is configured to determine a supply amount of hydrogen to be supplied from the hydrogen production facility to the energy resource based on the first information and the second information.

An energy trading system according to an embodiment of the present disclosure includes an information processing apparatus, a first energy management system, and a second energy management system. The first energy management system manages an energy resource in a managed area and transmits first information including planned values of a hydrogen purchase amount and a hydrogen purchase unit price to the information processing apparatus. The second energy management system manages a hydrogen production facility and transmits second information including planned values of a hydrogen sale amount and a hydrogen sale unit price to the information processing apparatus. The information processing apparatus determines a supply amount of hydrogen to be supplied from the hydrogen production facility to the energy resource based on the first information and the second information.

According to the present disclosure, energy can be used effectively by coordinating the supply amount and the supply price of hydrogen between independently operated and managed hydrogen stations and communities such as cities or regions.

### BRIEF DESCRIPTION OF THE DRAWINGS

In the accompanying drawings:

FIG. 1 is a block diagram illustrating a schematic configuration of an energy management system according to an embodiment of the present disclosure;

FIG. 2 is a block diagram illustrating an example configuration of an information processing apparatus in FIG. 1;

FIG. 3 is a block diagram illustrating an example configuration of energy resources and electricity consumers in FIG. 1;

FIG. 4 is a block diagram illustrating an example configuration of a community EMS in FIG. 1;

FIG. 5 is a block diagram illustrating an example configuration of a hydrogen station and hydrogen consumers in FIG. 1;

FIG. 6 is a block diagram illustrating an example configuration of a hydrogen station EMS in FIG. 1;

FIG. 7 is a block diagram illustrating an example configuration of a hydrogen supply line in FIGS. 1; and

FIG. 8 is a flowchart of processing in an energy trading system.

### DETAILED DESCRIPTION

An embodiment of the present disclosure will be described below, with reference to the drawings. The drawings used in the following description are schematic. Dimensional ratios or the like on the drawings do not necessarily match actual ones.

### Overall Configuration of System

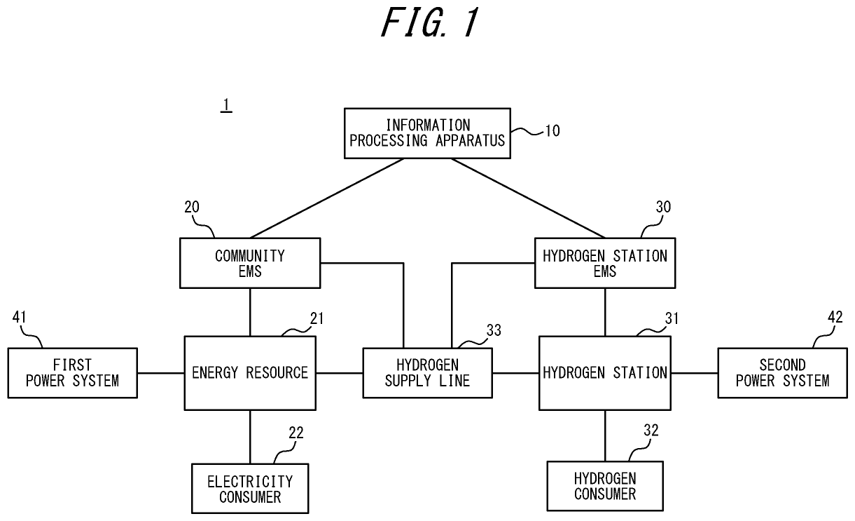

An energy trading system 1 is established to optimize the use of hydrogen between communities, such as cities and regions, and nearby hydrogen stations. The energy trading system 1 is configured to include an information processing apparatus 10, a community EMS 20, and a hydrogen station EMS 30, as illustrated in FIG. 1. EMS stands for Energy Management System. The community EMS 20 is a first energy management system. The hydrogen station EMS 30 is a second energy management system.

### Information Processing Apparatus

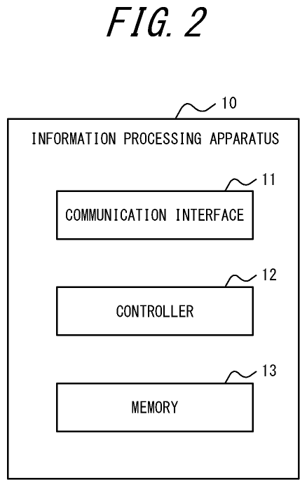

The information processing apparatus 10 is a computer. For example, the information processing apparatus 10 may be any of a personal computer (PC) server, a workstation, and a general purpose computer. The information processing apparatus 10 is configured to transmit and receive information to and from the community EMS 20 and the hydrogen station EMS 30. As illustrated in FIG. 2, the information processing apparatus 10 includes a communication interface 11, a controller 12, and a memory 13.

The communication interface 11 includes a communication module for communicating with the community EMS 20 and the hydrogen station EMS 30. The communication interface 11 may be connected to the community EMS 20 and the hydrogen station EMS 30 via an exclusive line or a virtual private network (VPN). The communication interface 11 serves as the first acquisition interface and the second acquisition interface.

The controller 12 executes the information processing performed by the information processing apparatus 10. The controller 12 includes at least one processor. “Processors” include general purpose processors that execute programmed functions by loading a specific program, and dedicated processors that are dedicated to specific processing. Dedicated processors may include Digital Signal Processors (DSPs), Application Specific Integrated Circuits (ASICs), Field-Programmable Gate Arrays (FPGAs), and the like. The controller 12 can execute processing based on system programs, application programs, and the like stored in the memory 13.

The memory 13 stores any information to be used for the operations of the information processing apparatus 10. For example, the memory 13 stores system programs and application programs. The memory 13 includes a semiconductor memory and/or a magnetic memory. Semiconductor memory includes read only memory (ROM), random access memory (RAM), flash memory, and the like. RAM includes dynamic random access memory (DRAM) and static random access memory (SRAM). Magnetic memory includes hard disks. The memory 13 may function as, for example, a main memory, an auxiliary memory, or a cache memory.

The community EMS 20 and the hydrogen station EMS 30 are computers, like the information processing apparatus 10. The community EMS 20 and the hydrogen station EMS 30 have components equivalent to the communication interface 11, the controller 12, and the memory 13 of the information processing apparatus 10.

The community EMS 20 manages energy resources 21 distributed in a community that is the managed area. The community EMS 20 predicts the amount of electricity demanded by electricity consumers 22 in the community, along with the amount of electricity supplied by power generation facilities, storage facilities, and the like, during a predetermined period. Examples of the predetermined period are, with reference to the present, one year, six months, one month, or one day, such as two days later, the next day, or the current day, but these examples are not limiting. The community EMS 20 formulates an energy operation plan for a plurality of predetermined periods of different lengths. The community EMS controls the energy resource 21 so that electricity is supplied according to the operation plan during a predetermined period. The community EMS 20 purchases electricity from a first power system 41 as needed.

The hydrogen station EMS 30 manages the electricity used by the hydrogen station 31 near the community to produce hydrogen and manages the produced hydrogen. The hydrogen station EMS 30 predicts the hydrogen demand of hydrogen consumers 32, such as fuel cell electric vehicles (FCEVs). The hydrogen station EMS 30 can provide a portion of the hydrogen produced at the hydrogen station 31 to the energy resources 21 of the community through a hydrogen supply line 33. The hydrogen station EMS 30 predicts the amount of generated renewable electricity that does not produce carbon dioxide (CO₂-free electricity) based on weather forecasts and the like in the vicinity of the hydrogen station 31. The hydrogen station EMS 30 formulates a hydrogen production plan for a predetermined period. The hydrogen production plan includes the amount of hydrogen to be produced and a plan for the procurement of electricity to be used in the production of the hydrogen. The hydrogen station EMS 30 can receive power supply from a second power system 42 as needed.

The controller 12 of the information processing apparatus 10 acquires the first information, which includes planned values of the hydrogen purchase amount and hydrogen purchase unit price for a predetermined period, from the community EMS 20 via the communication interface 11. The first information may include information on planned values of the hydrogen purchase amount and the hydrogen purchase unit price for each time slot. The controller 12 acquires the second information, which includes planned values of the hydrogen sale amount and hydrogen sale unit price for a predetermined period, from the hydrogen station EMS 30 via the communication interface 11. The second information may include information on planned values of the hydrogen sale amount and the hydrogen sale unit price for each time slot. Based on the first and second information, the controller 12 determines the supply amount of hydrogen to be supplied from the hydrogen station 31 to the community energy resource 21 during the predetermined period. The controller 12 can transmit the determined supply amount of hydrogen and/or the amount of hydrogen to be produced at the hydrogen station 31 to the community EMS 20 and the hydrogen station EMS 30 via the communication interface 11. The controller 12 can also store the determined supply amount of hydrogen for the predetermined period in the memory 13.

In an embodiment, the information processing apparatus 10 may acquire the first information and the second information for the next day by a predetermined time each day and adjust the supply amount and supply unit price of hydrogen to be supplied from the hydrogen station 31 to the energy resource 21 of the community on the next day. The predetermined time can, for example, be noon or 3:00 p.m. Information on the weather forecast for the next day is reflected in the supply amount and the unit price of hydrogen.

### Energy Resources

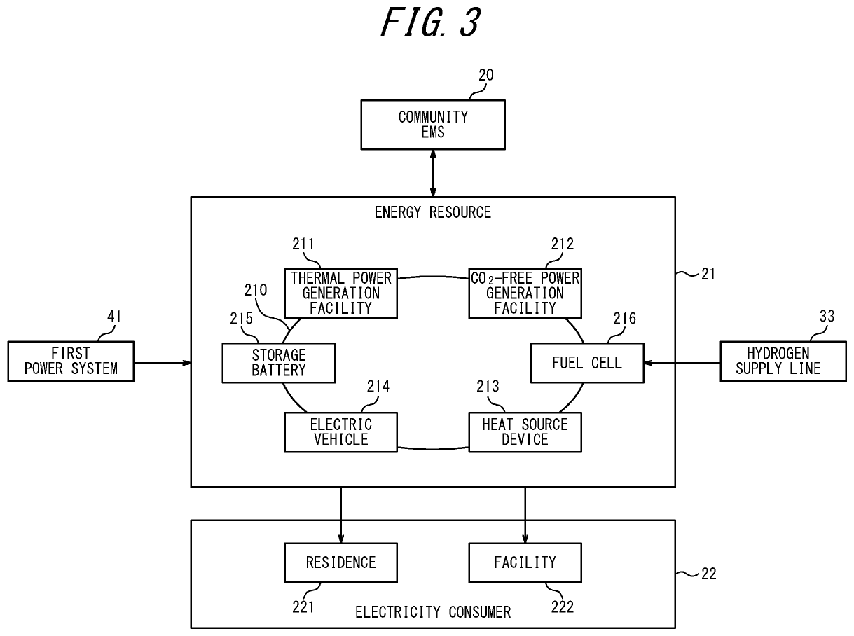

The energy resources 21 managed by the community EMS 20 are configured to include thermal power generation facilities 211, CO₂-free power generation facilities 212, heat source devices 213, electric vehicles (EVs) 214, and/or storage batteries 215 connected by a power grid 210, as illustrated in FIG. 3. The energy resources 21 further include a fuel cell 216.

The power grid 210 can transmit and receive electricity and information about electricity. The community EMS 20 can acquire information from the energy resources 21 connected to the power grid 210, such as the amount of surplus electricity that can be supplied and the amount of stored electricity. The community EMS 20 can control each energy resource 21 via the power grid 210. The community EMS 20 and the energy resources 21 form a virtual power plant (VPP).

The thermal power generation facilities 211 are power generation facilities that burn fuel to generate electricity and are installed in hospitals, factories, commercial facilities, and the like in the community. The thermal power generation facilities 211 include power generation facilities that use waste heat generated at factories, waste treatment plants, and the like. The thermal power generation facilities 211 include, for example, gas turbine power generators and steam turbine power generators. The thermal power generation facilities 211 can generate and supply heat along with electricity to the community. This enables the thermal power generation facilities 211 to use fuel with high energy efficiency.

The CO₂-free power generation facilities 212 are power generation facilities that do not produce carbon dioxide or other greenhouse gases in the community. The CO₂-free power generation facilities 212 include, for example, photovoltaic (PV), wind, and geothermal power generation facilities. For example, solar panels installed on a residential or commercial building are included in the CO₂-free power generation facilities 212.

The heat source devices 213 include heat pump water heaters, air conditioning equipment, lighting equipment, and other such equipment in residences, buildings, and the like. These heat source devices 213 can suppress the electricity demand when the electricity demand is high, i.e., can be used for demand response (DR). In other words, the community EMS 20 can lower the amount of electricity supplied to the heat source devices 213 when the electricity demand in the community is high. The heat source devices 213 may include a heat storage tank capable of storing heat. The heat storage tank may switch between heat storage and heat dissipation according to the amount of electricity supplied.

The EV 214 includes a large drive battery and can be charged and discharged, via the appropriate charging/discharging facilities, relative to the power grid 210 in the community. The EV 214 can therefore be used to adjust the electricity supply and demand in the community. EVs 214 include battery electric vehicles (BEVs) and hybrid electric vehicles (HEVs). EVs 214 include, for example, EVs 214 owned by public agencies, individuals, businesses, car-share operators, and car rental companies.

The storage batteries 215 are located in residences, business offices, or the like. The storage batteries 215 may be located adjacent to thermal power generation facilities 211 or CO₂-free power generation facilities 212 to store the electricity generated by these facilities. The operator of the community EMS 20 may also own large-scale storage batteries to respond to fluctuations in the supply and demand of electricity.

The fuel cell 216 generates electricity using hydrogen supplied from the hydrogen station 31 via the hydrogen supply line 33. The fuel cell 216 is operated and managed by the community EMS 20. The fuel cell 216 generates water and electricity from hydrogen and from the oxygen in the air. The electricity generated by the fuel cell 216 is CO₂-free electricity in the case of being generated using CO₂-free hydrogen, which is generated without producing carbon dioxide.

Electricity from the energy resources 21 is supplied to the electricity consumers 22, i.e., residences 221 of general households and facilities 222 of businesses and the like. In a case in which the energy resources 21 in the community alone cannot meet the energy demands of the electricity consumers 22, the community EMS 20 receives a supply of grid electricity from the first power system 41. The first power system 41 is a system that transforms, transmits, and distributes electricity generated by large-scale power plants.

The operator of the community EMS 20 purchases electricity from the first power system 41. The community EMS 20 reserves electricity to be purchased from the first power system 41 based on the predicted electricity demand for a predetermined period. In a case in which a predetermined period is actually reached and the electricity demand by the electricity consumers 22 exceeds the prediction, requiring the purchase of more electricity from the first power system 41 than the reserved amount of electricity, the community EMS 20 can purchase additional electricity by paying a higher unit price than what was reserved in advance.

The electricity supplied by the first power system 41 includes electricity that generates carbon dioxide by burning fossil fuels and the like and CO₂-free electricity generated by power generation facilities that do not produce carbon dioxide or other greenhouse gases. The operator of the community EMS 20 can contract in advance for CO₂-free electricity to be included in the power purchased from the first power system 41. The community EMS 20 can designate CO₂-free electricity to be a portion or all of the electricity purchased from the first power system 41.

### Community EMS

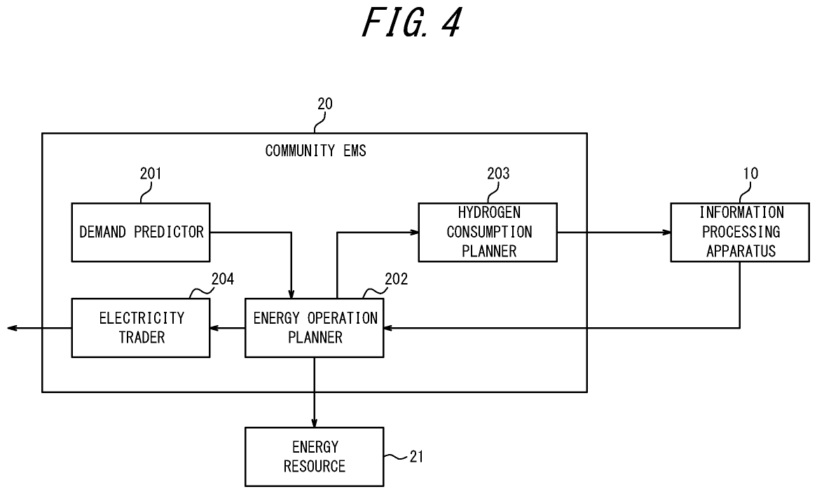

The community EMS 20 includes the following functional blocks, as illustrated in FIG. 4: a demand predictor 201, an energy operation planner 202, a hydrogen consumption planner 203, and an electricity trader 204. The processing of each functional block is executed by the controller (processor) included in the community EMS 20. Each functional block may be executed by the same processor in the community EMS 20 or by different processors in the community EMS 20.

The demand predictor 201 predicts the electricity demand of the electricity consumers 22 in the community managed by the community EMS 20. The demand predictor 201 may predict the electricity demand based on information about past electricity demand, forecasts for weather and temperature, information on events in the community, and the like. To this end, the community EMS 20 may be configured to communicate with external information sources that provide weather information and/or event information and the like.

The energy operation planner 202 determines an energy operation plan for a predetermined period based on the electricity demand predicted by the demand predictor 201. The energy operation plan includes a plan for procurement of electricity, control of electricity use, and the like in correspondence with the electricity demand. The energy operation planner 202 predicts the electricity generation amount during a predetermined period by the thermal power generation facilities 211 and CO₂-free power generation facilities 212 included in the energy resources 21. The energy operation planner 202 determines the energy operation plan taking into account the electricity purchase price contracted with the first power system 41 and the market price of electricity.

In a case in which the electricity generated by the thermal power generation facilities 211 and the CO₂-free power generation facilities 212 is less than the electricity demand by the electricity consumers 22, the energy operation planner 202 may formulate a plan to reduce the electricity supplied to the heat source devices 213 and/or the EVs 214. The energy operation planner 202 may also formulate a plan to discharge the electricity stored in the EVs 214 and storage batteries 215. Furthermore, the energy operation planner 202 may incorporate, into the energy operation plan, the generation of electricity by the fuel cell 216 that receives a supply of hydrogen from the hydrogen supply line 33 and the receipt of grid electricity supplied from the first power system 41.

In a case in which the electricity generated by the thermal power generation facilities 211 and the CO₂-free power generation facilities 212 exceeds the electricity demand by the electricity consumers 22, the energy operation planner 202 may create the energy operation plan so that the surplus electricity is stored in the EVs 214 and/or the storage batteries 215.

The energy operation planner 202 may also create the energy operation plan taking into account the price of electricity to be purchased from the first power system 41 and the price of hydrogen to be purchased from the hydrogen station 31. Therefore, the energy operation planner 202 is configured to acquire information on the amount and price of electricity and hydrogen that can be purchased. The energy operation planner 202 may create the energy operation plan so that electricity and/or hydrogen is purchased when the purchase price is low, and the electricity generated from the purchased electricity and/or purchased hydrogen is then stored in the storage battery 215.

The energy operation plan includes a purchase plan for electricity and hydrogen for each time slot in a predetermined period. The energy operation planner 202 may, for example, create the energy operation plan so that the purchase of electricity from the first power system 41 during peak periods of electricity demand when the price of grid electricity is high is suppressed, and so that grid electricity is purchased in time slots when the price of grid electricity is low, such as at night. The energy operation planner 202 may, for example, create the operation plan so that hydrogen is purchased in a case in which the unit price of electricity that can be generated from hydrogen is determined to be lower than the unit price of grid electricity from the first power system 41.

The energy operation planner 202 prepares the energy operation plan for a predetermined period at a predetermined timing. For example, the energy operation planner 202 prepares an energy operation plan for a predetermined period by a given date in order to reserve electricity to be purchased from the electricity market. For example, the energy operation planner 202 prepares an energy operation plan for a year or a month by the same date of the previous year or the previous month. For example, the energy operation planner 202 prepares an energy operation plan for one day by the end of morning on the previous day. The energy operation planner 202 may modify the created energy operation plan as needed based on information such as the latest weather, temperature, or traffic information.

The energy operation planner 202 can receive information from the information processing apparatus 10 on the supply amount of hydrogen and the unit price of hydrogen supplied by the hydrogen station 31. The energy operation planner 202 can update the energy operation plan based on this information.

The energy operation planner 202 creates the energy operation plan according to various constraints. For example, the operator of a community EMS 20 may make a commitment in advance, to the residents, businesses, and the like in the community, to provide a certain percentage of CO₂-free electricity among the supplied electricity. In such a case, the energy operation planner 202 determines the percentage of electricity to be purchased with the constraint that the percentage of CO₂-free electricity be at least the percentage committed to in advance. The energy operation planner 202 creates the energy operation plan to optimize a predetermined objective variable while satisfying constraints. For example, the predetermined objective variable is the cost of procuring electricity to sell to the electricity consumers 22. The energy operation planner 202 may create the energy operation plan to minimize this cost.

The hydrogen consumption planner 203 creates a hydrogen consumption plan that indicates the amount of hydrogen to be consumed by the fuel cell 216 for electricity generation in each time slot based on the energy operation plan created by the energy operation planner 202. The hydrogen consumption planner 203 transmits the created hydrogen consumption plan to the information processing apparatus 10.

After the hydrogen consumption planner 203 transmits the hydrogen consumption plan to the information processing apparatus 10, the energy operation planner 202 may receive recommended values for the supply amount and supply unit price of hydrogen from the information processing apparatus 10. The energy operation planner 202 further adjusts the energy operation plan based on this information. Based on the adjusted energy operation plan, the hydrogen consumption planner 203 again creates a hydrogen consumption plan and transmits the hydrogen consumption plan to the information processing apparatus 10. When, in the information processing apparatus 10, the purchase amount and the purchase unit price of hydrogen in the energy operation plan match the sale amount and the sale unit price of hydrogen for the hydrogen station EMS 30, the energy operation plan at that point in time is finalized.

The electricity trader 204 reserves the purchase of electricity from the first power system 41 by a predetermined date based on the energy operation plan created by the energy operation planner 202. Furthermore, in a case in which the energy operation planner 202 modifies the energy operation plan, the electricity trader 204 changes the purchase amount of electricity according to the details of the modification.

### Hydrogen Station

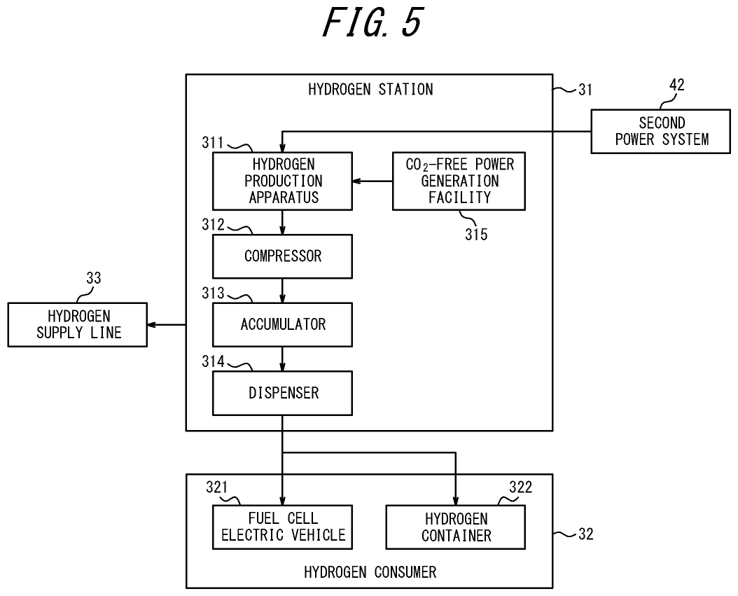

The hydrogen station 31 includes a hydrogen production apparatus 311, a compressor 312, an accumulator 313, a dispenser 314, and a CO₂-free power generation facility 315, as illustrated in FIG. 5.

The hydrogen production apparatus 311 is an apparatus that produces hydrogen. Hydrogen production methods include separation from fossil fuels, such as petroleum and natural gas, and production by electrolysis of water. In the hydrogen station 31 of the embodiment illustrated in FIG. 5, the hydrogen production apparatus 311 is an apparatus that produces hydrogen by electrolyzing water using electricity generated by the CO₂-free power generation facility 315 or grid electricity from the second power system 42. Hydrogen produced solely from CO₂-free electricity is called CO₂-free hydrogen or green hydrogen. The hydrogen station 31 may use CO₂-free electricity for all the electricity purchased from the second power system 42 in order for the produced hydrogen to be CO₂-free hydrogen.

The compressor 312 is an apparatus that compresses the hydrogen produced in the hydrogen production apparatus 311 to a predetermined pressure. The predetermined pressure is, for example, 700 to 800 atmospheres. Compressors 312 include mechanical compressors and electrochemical compressors.

The accumulator 313 is a container that temporarily stores the hydrogen compressed by the compressor 312 in a high-pressure state for purposes such as filling a fuel cell electric vehicle (FCEV) 321.

The dispenser 314 is an apparatus for filling the FCEV 321 with high-pressure hydrogen. The dispenser 314 monitors and controls the flow and temperature of hydrogen to ensure safe hydrogen filling.

The CO₂-free power generation facility 315, like the CO₂-free power generation facility 212 in the energy resource 21, is a power generation facility that does not produce carbon dioxide or other greenhouse gases. In the present embodiment, the CO₂-free power generation facility 315 is described below as being a photovoltaic power generation facility. In a case in which a large amount of electricity is generated by the CO₂-free power generation facility 212 in the hydrogen station 31, the electricity generated by the CO₂-free power generation facility 212 may be used preferentially, and the electricity from the second power system 42 may be used secondarily.

The hydrogen station 31 supplies the produced hydrogen to FCEVs 321, which are hydrogen consumers 32. The hydrogen station 31 may also fill hydrogen containers 322 with the produced hydrogen and transport the hydrogen containers 322 to other locations. Other locations include, for example, off-site hydrogen stations that do not have hydrogen production facilities. The hydrogen station 31 can further supply excess hydrogen to the fuel cell 216 of the energy resources 21 in the community via the hydrogen supply line 33.

### Hydrogen Station EMS

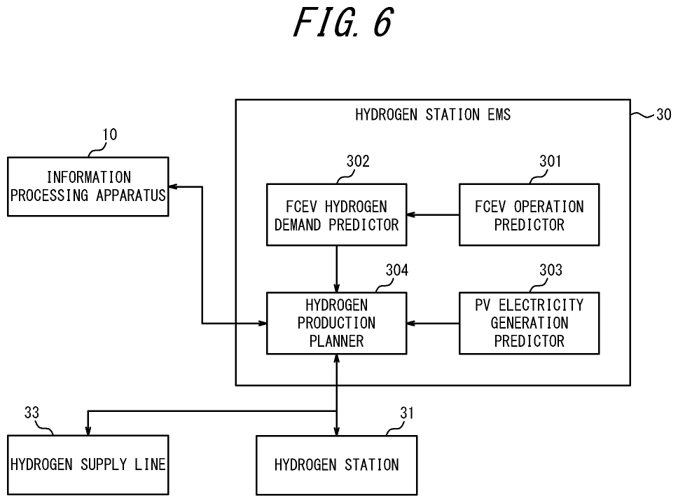

The hydrogen station EMS 30 includes an FCEV operation predictor 301, an FCEV hydrogen demand predictor 302, a PV electricity generation predictor 303, and a hydrogen production planner 304, as illustrated in FIG. 6.

The FCEV operation predictor 301 predicts the operation of the FCEVs 321 that might be filled with hydrogen at the hydrogen station 31. For example, some FCEVs 321 may be members registered as users of the hydrogen station EMS 30 to receive the supply of hydrogen. A driver who is a member may notify the hydrogen station EMS 30 in advance of the scheduled operation of the FCEV 321. The FCEV operation predictor 301 may also acquire past operation data for the FCEV 321 and predict the operation of the FCEV 321 during a predetermined period based on the operation record of the FCEV 321 on the same date of each month or the same day of the week. The FCEV operation predictor 301 may predict the number of FCEVs 321 that will fill up with hydrogen at the hydrogen station 31 during a predetermined period.

The FCEV hydrogen demand predictor 302 predicts the demand for hydrogen by the FCEVs 321 based on the operation of the FCEVs 321 predicted by the FCEV operation predictor 301.

The PV electricity generation predictor 303 predicts the amount of electricity generated by the CO₂-free power generation facility 315 of the hydrogen station 31. For example, the PV electricity generation predictor 303 may have information on the average amount of electricity generated by photovoltaic power generation at different times of the year. The PV electricity generation predictor 303 may be configured to acquire weather information, such as temperature and weather conditions, from an external weather information provider. The PV electricity generation predictor 303 may predict the amount of electricity generated by photovoltaic power generation based on the predicted weather conditions.

The hydrogen production planner 304 creates a hydrogen production plan for a predetermined period based on the predicted demand for hydrogen by the FCEVs 321, predicted by the FCEV hydrogen demand predictor 302, and the electricity generation amount from photovoltaic power generation, predicted by the PV electricity generation predictor 303. The hydrogen production plan specifies the means to be used, the time, and the amount of hydrogen to be produced. The hydrogen production planner 304 may create the hydrogen production plan assuming that hydrogen will be provided to the energy resource 21 of the community in a case in which excess hydrogen is produced based on the predicted electricity generation amount. The hydrogen production planner 304 may create the hydrogen production plan taking into account information such as the operation record of the hydrogen station 31, maintenance plans, and maintenance and management costs. The hydrogen production planner 304 may take into account factors such as the amount of hydrogen stored in the accumulator 313.

The hydrogen production planner 304 calculates the amount of electricity required to produce the amount of hydrogen predicted by the FCEV hydrogen demand predictor 302. The hydrogen production planner 304 may produce hydrogen using only the electricity produced by the CO₂-free power generation facility 212 in a case in which the electricity generation amount predicted by the PV electricity generation predictor 303 is greater than the electricity generation amount necessary to produce the amount of hydrogen according to the predicted demand. The hydrogen production planner 304 may produce hydrogen by receiving CO₂-free electricity from the second power system 42 in addition to the electricity produced by the CO₂-free generation facility 212 in a case in which the electricity generation amount predicted by the PV electricity generation predictor 303 is smaller than the electricity generation amount necessary to produce the amount of hydrogen according to the predicted demand.

The hydrogen production planner 304 transmits, to the information processing apparatus 10, a hydrogen supply plan that includes planned values of the hydrogen sale amount and hydrogen sale unit price for a predetermined period. The hydrogen supply plan specifies the conditions, methods, and the like for providing the produced hydrogen. The hydrogen supply plan is the second information. After transmitting the hydrogen supply plan, the hydrogen production planner 304 may receive, from the information processing apparatus 10, information on recommended values of the supply amount and supply unit price of hydrogen to be provided to the energy resources 21 of the community, and/or information on the amount of hydrogen to be produced. The hydrogen production planner 304 further adjusts the hydrogen supply plan and the hydrogen production plan based on this information. The hydrogen production planner 304 performs the process of transmitting the adjusted hydrogen supply plan to the information processing apparatus 10 again. When, in the information processing apparatus 10, the sale amount and the sale unit price of hydrogen in the hydrogen supply plan match the purchase amount and the purchase unit price of hydrogen for the community EMS 20, the hydrogen supply plan at the current point in time is finalized.

The hydrogen production planner 304 instructs the hydrogen station 31 to produce hydrogen at an appropriate timing. The hydrogen production planner 304 directs the hydrogen station 31 and the hydrogen supply line 33 to supply hydrogen to the fuel cell 216 included in the energy resources 21 of the community at an appropriate timing according to the hydrogen supply plan.

### Hydrogen Supply Line

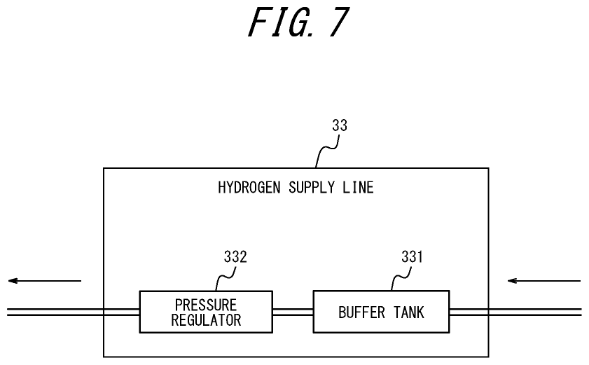

The hydrogen supply line 33 includes a buffer tank 331 and a pressure regulator 332 installed on the pipeline between the hydrogen station 31 and the energy resources 21, as illustrated in FIG. 7. The buffer tank 331 temporarily stores hydrogen supplied to the fuel cell 216 of the energy resource 21. The community EMS 20 and the hydrogen station EMS 30 can acquire the amount of hydrogen stored in the buffer tank 331. The pressure regulator 332 delivers the hydrogen stored in the buffer tank 331 to the fuel cell 216 in the energy resource 21 of the community. The hydrogen supply line 33 supplies a predetermined amount of hydrogen to the fuel cell 216 of the energy resource 21 at a predetermined time by adjusting the pressure regulator 332.

### Energy Trading Method

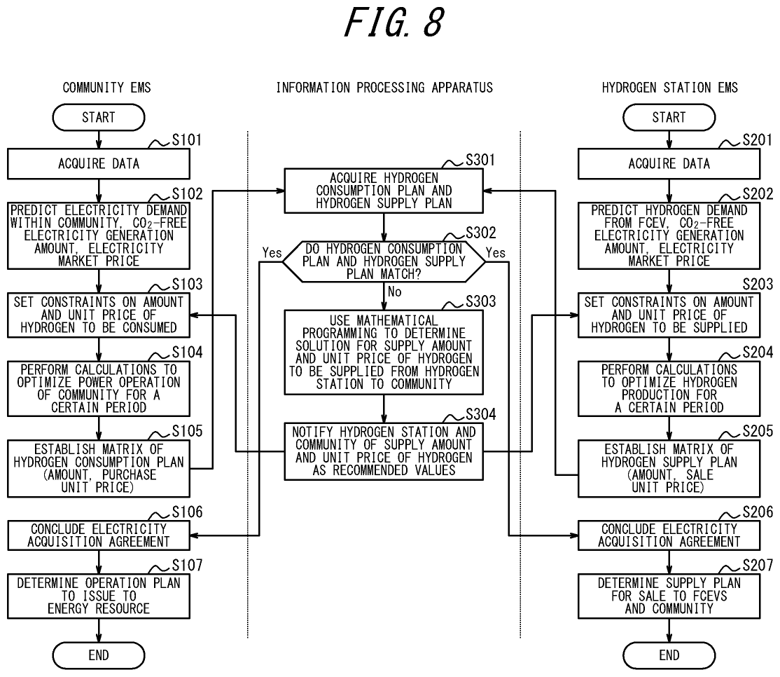

With reference to FIG. 8, the procedures for determining the supply amount and supply price of hydrogen to be supplied from the hydrogen station 31 to the energy resource 21 in the energy trading system 1 is described. In FIG. 8, the procedures performed by the community EMS 20 are steps S101 to S107. The procedures performed by the hydrogen station EMS 30 are steps S201 to S207. The procedures performed by the information processing apparatus 10 are steps S301 to S304. The community EMS 20 and the hydrogen station EMS 30 can execute processing separately.

First, the community EMS 20 acquires various data (step S101). The data acquired by the community EMS 20 includes calendar information, information on past electricity usage, information on events in the community, and weather information such as temperature and weather conditions. The data acquired by the community EMS 20 may include information on the amount of hydrogen remaining in the buffer tank 331 of the hydrogen supply line 33.

Using the demand predictor 201, the community EMS 20 makes various predictions based on the acquired data (step S102). First, using the energy operation planner 202, the community EMS 20 predicts the electricity demand in the community for each predetermined period. The community EMS 20 also predicts the amount of electricity generated by the CO₂-free power generation facility 212 based on the weather information and the like. In addition, the community EMS 20 predicts the market price of electricity that can be purchased from the first power system 41 during the predetermined period.

Using the energy operation planner 202, the community EMS 20 sets constraints on the amount and unit price of hydrogen to be consumed based on the predictions made in step S102 (step S103). For example, in a case in which the hydrogen supplied by the hydrogen station 31 is CO₂-free hydrogen, the community EMS 20 may set a lower limit on hydrogen consumption so that the CO₂-free electricity ratio of the electricity consumed in the community exceeds the target value. For example, the community EMS 20 may also set an upper limit on hydrogen consumption within a range such that the storage battery 215 can store the electricity generated by the fuel cell 216 using hydrogen. The community EMS 20 may also set an upper limit on the unit price of hydrogen to be consumed so that the unit price of electricity generated by the fuel cell 216 using hydrogen is less than the unit price of electricity that can be purchased from the first power system 41. In addition to the above constraints, the community EMS 20 can set constraints on the amount and unit price of hydrogen to be consumed according to various conditions.

Using the energy operation planner 202, the community EMS 20 performs calculations to optimize power operation for a certain period under the conditions set in step S103 (step S104). The certain period may include various periods of time with reference to the present time, such as one year, one month, one week, and one day. That is, the community EMS 20 may perform respective optimization calculations for a long term of years, a medium term of months, and a short term of days. In the case of performing long-term optimization calculations, the community EMS 20 may include changes to the contract with the first power system 41 and perform the optimization calculations. In the case of performing short-term optimization calculations, the community EMS 20 may perform optimization calculations assuming that the price and purchase conditions of grid electricity are as contracted with the first power system 41.

The community EMS 20 can use a variety of variables as optimization objectives. For example, the community EMS 20 may minimize the total of all of the costs for the electric utilities that supply electricity to the community as the optimization objective. All of the costs for the electric utilities include the cost of fuel, including hydrogen, for electricity generation, the cost of purchasing grid electricity, the cost of purchasing electricity from energy resources 21 owned by other companies, and the cost of constructing, maintaining, and operating any owned energy resources 21.

The optimization objective is not limited to minimizing the cost of the electric utilities. For example, the community EMS 20 may set a constraint to keep the sum of all costs of the electric utilities equal to or less than a predetermined amount in step S103 and may set the maximization of the CO₂-free electricity ratio as an objective in step S104.

As a result of the optimization calculations, the community EMS 20 determines an energy operation plan that indicates what proportion of each power source will be used at what time and how much electricity will be supplied. The power sources include the thermal power generation facility 111, the CO₂-free power generation facility 212, the storage battery 215, the fuel cell 216, and the first power system 41. The energy operation plan includes, as necessary, a plan for reducing the charging of the EVs 214 and reducing the electricity supply to the heat source devices 213. A shorter-term energy operation plan may be used to readjust at least a portion of a longer-term energy operation plan established in the past.

In the optimization calculation of step S104, the energy operation plan may be determined with hydrogen purchase conditions as variables, since conditions such as the unit price and the purchasable amount of hydrogen to be purchased from the hydrogen station 31 have not yet been finalized.

The community EMS 20 determines the matrix of the hydrogen consumption plan based on the energy operation plan determined in step S104 (step S105). The matrix of the hydrogen consumption plan is the first information. The matrix of the hydrogen consumption plan is data in matrix format that includes at least three variables as elements, i.e., the purchase amount, the purchase timing, and the purchase unit price of hydrogen to be purchased by the community EMS 20. The data for each element may have a range rather than a single value. The matrix of the hydrogen consumption plan illustrates the conditions for the community EMS 20 to purchase hydrogen. The community EMS 20 transmits the determined matrix of the hydrogen consumption plan to the information processing apparatus 10.

Next, the processing of steps S201 to S205 by the hydrogen station EMS 30 is described. Steps S201 to S205 may be performed independently of steps S101 to S105 in the community EMS 20.

First, the hydrogen station EMS 30 acquires various data (step S201). The data acquired by the hydrogen station EMS 30 includes weather information such as temperature and weather conditions, prediction data for the operation of a large number of FCEVs 321, historical market price data for electricity, and operation records, maintenance plans, and the like for the facilities in the hydrogen station 31. The prediction data for the operation of the FCEVs 321 may be predicted by the FCEV operation predictor 301 based on the operation schedule of registered FCEVs 321, along with the weather conditions, date and day of the week, and the like.

The hydrogen station EMS 30 makes various predictions based on the data acquired in step S201 (step S202). First, using the FCEV hydrogen demand predictor 302, the hydrogen station EMS 30 predicts the hydrogen demand from the FCEVs 321. Using the PV electricity generation predictor 303, the hydrogen station EMS 30 also predicts the amount of electricity generated by the CO₂-free power generation facility 315 of the hydrogen station 31. In addition, the hydrogen station EMS 30 predicts the market price of electricity that can be purchased from the second power system 42 during the predetermined period.

Using the hydrogen production planner 304, the hydrogen station EMS 30 sets constraints on the amount and unit price of hydrogen that can be supplied based on the predictions made in step S202 (step S203). For example, in a case in which it is estimated that there will be a surplus of hydrogen produced by the CO₂-free power generation facility 212 of the hydrogen station 31, the hydrogen station EMS 30 may set the sum of the surplus hydrogen and the hydrogen stored in the pressure accumulator 313 and the buffer tank 331 as the maximum amount of hydrogen that can be sold.

The hydrogen station EMS 30 may also set a lower limit on the unit price of hydrogen to be supplied based on all of the costs associated with the construction, operation, and maintenance of the hydrogen station 31. The hydrogen station EMS 30 may set a lower limit on the unit cost of hydrogen by adding a target profit margin to the cost of producing hydrogen per unit volume, as calculated from all of the above-described costs. In addition to the above constraints, the hydrogen station EMS 30 can set constraints on the amount and unit price of hydrogen to be supplied according to various conditions.

Using the hydrogen production planner 304, the hydrogen station EMS 30 performs optimization calculations for hydrogen production at the hydrogen station 31 for a certain period under the conditions set in step S203 (step S204). The certain period is the same period as the period for which the optimization calculation in step S104 was performed in the community EMS 20. The hydrogen station EMS 30 can use a variety of variables as optimization objectives. For example, the hydrogen station EMS 30 may, as the optimization objective, maximize the profit from hydrogen sales totaled over the entire period from construction to disposal of the hydrogen station EMS 30.

The optimization objective is not limited to maximizing profits from hydrogen sales by the hydrogen station 31. The hydrogen station EMS 30 can use a variety of variables as optimization objectives. For example, the hydrogen station EMS 30 may have the optimization objective of maximizing the utilization rate of the hydrogen station 31.

As a result of the optimization calculations, the hydrogen station EMS 30 determines the hydrogen production plan. The hydrogen production plan includes information indicating when and in what proportion the CO₂-free electricity from the CO₂-free power generation facility 212 and the electricity supplied by the second power system 42 are to be used to produce hydrogen.

In the optimization calculation of step S204, the hydrogen production plan may be determined with hydrogen supply conditions as variables, since conditions such as the supply amount and unit price of hydrogen to be supplied to the energy resource 21 of the community have not yet been finalized. For example, if the supply amount of hydrogen is large and the supply unit price is high, the hydrogen station 31 can produce a large quantity of hydrogen even if the cost of electricity used is high. In a case in which the supply amount of hydrogen is large but the supply unit price is low, the hydrogen station 31 might only be able to produce a small amount of hydrogen, since hydrogen is produced using electricity at a cost that matches the price.

The hydrogen station EMS 30 determines the matrix of the hydrogen supply plan for the fuel cell 216 based on the hydrogen production plan determined in step S204 (step S205). The matrix of the hydrogen supply plan is the second information. The matrix of the hydrogen supply plan is data in matrix format that includes at least three variables as elements, i.e., the sale amount, the sale timing, and the sale unit price of hydrogen to be supplied by the hydrogen station EMS 30. The data for each element may have a range rather than a single value. The matrix of the hydrogen supply plan indicates the conditions for the hydrogen station EMS 30 to sell hydrogen. The hydrogen station EMS 30 transmits the determined matrix of the hydrogen supply plan to the information processing apparatus 10.

In step S301, the information processing apparatus 10 acquires the matrix (first information) of the hydrogen consumption plan from the community EMS 20. In step S301, the information processing apparatus 10 also acquires the matrix of the hydrogen supply plan (second information) from the hydrogen station EMS 30.

The information processing apparatus 10 compares the hydrogen consumption plan acquired from the community EMS 20 with the hydrogen supply plan acquired from the hydrogen station EMS 30. The information processing apparatus 10 determines whether the hydrogen purchase amount and the hydrogen purchase unit price in the hydrogen consumption plan and the hydrogen sale amount and the hydrogen sale unit price in the hydrogen supply plan at least partially match (step S302).

In a case in which the hydrogen purchase amount and hydrogen purchase unit price in the hydrogen consumption plan and the hydrogen sale amount and the hydrogen sale unit price in the hydrogen supply plan match (step S302: Yes), the supply amount and the supply unit price of hydrogen are determined based on the matching information. The supply amount and the supply unit price of hydrogen may be determined as time series data that varies with the scheduled supply time. The information processing apparatus 10 transmits information on the determined supply amount and supply unit price of hydrogen to the community EMS 20 and the hydrogen station EMS 30.

Upon receiving the supply amount of hydrogen from the information processing apparatus 10, the community EMS 20 concludes or changes an electricity purchase agreement with the first power system 41 as necessary, taking into account the amount of electricity generated by the fuel cell 216 that receives the supply of hydrogen to generate electricity (step S106). The electricity purchase agreement includes an agreement to purchase electricity from the spot market. The community EMS 20 can reduce the purchase of electricity from the more expensive first power system 41 in a case in which more electricity is generated by the fuel cell 216.

The community EMS 20 also determines the operation plan to be issued to each energy resource 21, taking into account the amount of electricity generated by the fuel cell 216 (step S107). The operation plan includes the operating hours and the electricity generation amount of the thermal power generation facility 211 and the CO₂-free power generation facility, along with the amount of electricity stored in the storage battery 215 for each time slot. In addition, the operation plan includes the amount of electricity generated by the fuel cell 216 and the operating time thereof.

On the other hand, upon receiving the supply amount of hydrogen from the information processing apparatus 10, the hydrogen station EMS 30 concludes or changes an electricity purchase agreement with the second power system 42 as necessary, taking into account the amount of hydrogen to be supplied to the energy resource 21 of the community (step S206).

The hydrogen station EMS 30 also determines a supply plan for hydrogen to be sold to the hydrogen consumers 32, such as the FCEVs 321, and the community (step S207).

Returning to step S302 in the information processing apparatus 10, in a case in which the hydrogen purchase amount and hydrogen purchase unit price in the hydrogen consumption plan and the hydrogen sale amount and the hydrogen sale unit price in the hydrogen supply plan do not match (step S302: No), the information processing apparatus 10 proceeds to the next step S303. In step S303, the information processing apparatus 10 uses mathematical programming to find a solution for the supply amount and unit price of hydrogen to be supplied from the hydrogen station 31 to the energy resource 21 (step S303).

In a case in which the matrix in the hydrogen consumption plan and the matrix in the hydrogen supply plan are discrete values and no matching solution is found in step S302, then a solution exists between the discrete values of the matrices. Hence, the information processing apparatus 10 may search for this solution using linear programming.

The information processing apparatus 10 calculates the supply amount, supply timing, and unit price of hydrogen so as to reduce the cost of procuring electricity for the community as compared to the case of no hydrogen supply and to increase the profit on the sale of hydrogen produced by the hydrogen station 31. The supply amount and the unit price of hydrogen can have a certain range rather than being a single value.

The information processing apparatus 10 may calculate the supply amount, supply timing, and unit price of hydrogen so as to minimize the total purchase cost of the electricity purchased by the community EMS 20 from the first power system 41 and the electricity purchased by the hydrogen station EMS 30 from the second power system 42.

Furthermore, the information processing apparatus 10 may calculate the supply amount, supply timing, and unit price of hydrogen using, as a constraint, the hydrogen supply capacity of the hydrogen supply line 33 that supplies hydrogen from the hydrogen station 31 to the energy resources 21.

In addition to the above-described methods, the information processing apparatus 10 may calculate the supply amount and the supply unit price of hydrogen by various other methods.

The information processing apparatus 10 notifies the community EMS 20 and the hydrogen station EMS of the supply amount and the unit price of hydrogen, determined in step S303, as recommended values (step S304). The community EMS 20 performs the processing from step S103 onward again based on the received recommended values of the supply amount and the supply unit price of hydrogen. The hydrogen station EMS 30 performs the processing from step S203 onward again based on the received recommended values of the supply amount and the supply unit price of hydrogen. In steps S103 and S203, the constraints are set closer to the recommended hydrogen supply and supply unit prices received from the community EMS 20.

Subsequently, the processing by the community EMS 20 in steps S103 to S105, by the hydrogen station EMS 30 in steps S203 to S205, and by the information processing apparatus 10 in steps S301 to S304 is repeated. As the processing is repeated, the difference between the hydrogen purchase amount and the hydrogen purchase unit price in the hydrogen consumption plan of the community EMS 20 and the hydrogen sale amount and the hydrogen sale unit price in the hydrogen supply plan of the hydrogen station EMS 30 narrows. Consequently, after iterative calculations, the supply amount and the supply unit price of hydrogen are determined in step S302.

In the flowchart in FIG. 8, in a case in which the hydrogen consumption plan and the hydrogen supply plan do not match in step S302 after a predetermined number of iterative calculations, the energy trading system 1 may abort the processing. In this case, the information processing apparatus 10 may determine that a hydrogen supply transaction was not concluded.

As explained above, in the energy trading system 1 of the present disclosure, the information processing apparatus 10 acquires the planned values of the hydrogen purchase amount and purchase unit price (first information) for the community EMS 20 and the planned values of the hydrogen sale amount and the sale unit price (second information) for the hydrogen station EMS 30. The information processing apparatus 10 determines the supply amount and supply unit price of hydrogen to be supplied from the hydrogen station 31 to the energy resources 21 taking into account the first information and the second information. The determined supply amount and supply price of hydrogen thus reflect the conditions of the community EMS 20 and the hydrogen station EMS 30. In this way, an embodiment of the present disclosure can adjust the supply amount and supply unit price of hydrogen to the energy resources 21 of the community from the hydrogen station 31, which are independently operated and managed. As a result, energy can be used more effectively.

In addition, according to the present disclosure, the cost for supplying electricity can be reduced while meeting the requirements imposed on the community EMS 20, such as achieving the target CO₂-free electricity ratio. This enables the community EMS 20 to meet the demand for decarbonization of the electricity consumers 22 in the community while increasing the profitability of the electric utilities in the community.

Furthermore, according to the energy trading system 1 of the present disclosure, means are provided to coordinate the demand for hydrogen from the energy resources 21 in the community with the supply of hydrogen from the hydrogen station 31. This can increase the utilization rate of the hydrogen station 31 and reduce the amount of hydrogen that is disposed of without being used. As a result, the overall profitability of the hydrogen station 31 can be increased.

It should be noted that the present disclosure is not limited to the above embodiment, and various modifications and revisions can be implemented. For example, functions or the like included in each means, each step, or the like can be rearranged without logical inconsistency, and a plurality of means, steps, or the like can be combined into one or divided.

For example, the first energy management system has been described as having a community, such as a city or region, as the managed area. The managed area in the present disclosure is not limited to communities. For example, the managed area may span a plurality of administrative regions or cities. The managed area may be a redevelopment area including one or more large buildings and facilities, or a region such as an industrial park.

In the above embodiment, hydrogen is traded between a single community and a single hydrogen station 31. However, the first energy management system and the second energy management system that trade hydrogen need not be in one-to-one correspondence. There may be more than one of the first energy management system and/or the second energy management system. The information processing apparatus may perform processing to determine the supply amount and unit price of hydrogen between one or more first energy management systems and one or more second energy management systems.

In the above embodiment, hydrogen is transported from the hydrogen station 31 to the energy resource 21 (fuel cell 216) of the community by the hydrogen supply line 33. Hydrogen may, however, be transported by transport vehicles, rather than through a pipeline, in compressed form in containers. In the above embodiment, electricity is generated from hydrogen using fuel cells. However, the energy resource 21 may include other energy generating facilities that use hydrogen to generate energy. Other energy generating facilities include, for example, hydrogen power generation facilities in which hydrogen is burned in a gas turbine or the like to extract electrical energy.

The method included in the present disclosure can be executed by a program. For example, the procedures performed by the information processing apparatus 10 disclosed in FIG. 8 can be performed according to a program by the processor in the controller 12 of the information processing apparatus 10. Such a program may be stored in a non-transitory computer readable medium. Examples of non-transitory computer readable media may include, but are not limited to, a hard disk, RAM, ROM, flash memory, a CD-ROM, an optical storage device, and a magnetic storage device.

1. An energy trading method to be performed by an information processing apparatus, the energy trading method comprising:
acquiring first information including planned values of a hydrogen purchase amount and a hydrogen purchase unit price from a first energy management system that manages an energy resource in a managed area;
acquiring second information including planned values of a hydrogen sale amount and a hydrogen sale unit price from a second energy management system that manages a hydrogen production facility; and
determining a supply amount and a unit price of hydrogen to be supplied from the hydrogen production facility to the energy resource based on the first information and the second information.

2. The energy trading method according to claim 1, wherein the first information is data in a matrix format that includes respective planned values of a purchase amount, a purchase timing, and a purchase unit price of hydrogen as elements, and the second information is data in a matrix format that includes respective planned values of a sale amount, a sale timing, and a sale unit price of hydrogen as elements.

3. The energy trading method according to claim 1, wherein in a case in which the first information and the second information are matching information, a supply amount, a supply timing, and a supply price of hydrogen from the hydrogen production facility to the managed area are determined based on the matching information.

4. The energy trading method according to claim 1, wherein after the supply amount of the hydrogen is determined, an operation plan for a fuel cell that is included in the energy resource managed by the first energy management system and generates electricity by receiving supply of the hydrogen is created and transmitted to the first energy management system, the operation plan including an electricity generation amount and an operating time of the fuel cell.

5. The energy trading method according to claim 1, wherein in a case in which the first information and the second information do not match, recommended values of a supply amount, a supply timing, and a unit price of the hydrogen are determined, the determined recommended values are transmitted to the first energy management system and the second energy management system, an update of the first information is acquired from the first energy management system, and an update of the second information is acquired from the second energy management system.

6. The energy trading method according to claim 5, wherein the first energy management system is configured to purchase at least a portion of electricity supplied to the managed area from a first power system, the second energy management system is configured to purchase at least a portion of electricity supplied to the hydrogen production facility from a second power system, and the information processing apparatus determines the supply amount, the supply timing, and the unit price of the hydrogen so as to minimize a total purchase cost of electricity from the first power system and the second power system during a predetermined period.

7. The energy trading method according to claim 5, wherein the recommended values of the supply amount, the supply timing, and the unit price of the hydrogen are determined so as to reduce a cost for procuring electricity to supply to the managed area and to increase profit on a sale of hydrogen produced by the hydrogen production facility.

8. The energy trading method according to claim 5, wherein the recommended values of the supply amount, the supply timing, and the unit price of the hydrogen are determined using, as a constraint, a hydrogen supply capacity of a hydrogen supply line that supplies hydrogen from the hydrogen production facility that is managed by the second energy management system to the energy resource in the managed area that is managed by the first energy management system.

9. An information processing apparatus comprising:
a first acquisition interface configured to acquire first information including planned values of a hydrogen purchase amount and a hydrogen purchase unit price from a first energy management system that manages an energy resource in a managed area;
a second acquisition interface configured to acquire second information including planned values of a hydrogen sale amount and a hydrogen sale unit price from a second energy management system that manages a hydrogen production facility; and
a controller configured to determine a supply amount of hydrogen to be supplied from the hydrogen production facility to the energy resource based on the first information and the second information.

10. The information processing apparatus according to claim 9, wherein the first information is data in a matrix format that includes respective planned values of a purchase amount, a purchase timing, and a purchase unit price of hydrogen as elements, and the second information is data in a matrix format that includes respective planned values of a sale amount, a sale timing, and a sale unit price of hydrogen as elements.

11. The information processing apparatus according to claim 9, wherein in a case in which the first information and the second information are matching information, the controller is configured to determine a supply amount, a supply timing, and a supply price of hydrogen from the hydrogen production facility to the managed area based on the matching information.

12. The information processing apparatus according to claim 9, wherein after the supply amount of the hydrogen is determined, the controller is configured to create an operation plan for a fuel cell that is included in the energy resource managed by the first energy management system and generates electricity by receiving supply of the hydrogen and transmit the operation plan to the first energy management system, the operation plan including an electricity generation amount and an operating time of the fuel cell.

13. The information processing apparatus according to claim 9, wherein in a case in which the first information and the second information do not match, the controller is configured to determine recommended values of a supply amount, a supply timing, and a unit price of the hydrogen, transmit the determined recommended values to the first energy management system and the second energy management system, acquire an update of the first information from the first energy management system, and acquire an update of the second information from the second energy management system.

14. The information processing apparatus according to claim 13, wherein the first energy management system is configured to purchase at least a portion of electricity supplied to the managed area from a first power system, the second energy management system is configured to purchase at least a portion of electricity supplied to the hydrogen production facility from a second power system, and the controller is configured to determine the supply amount, the supply timing, and the unit price of the hydrogen so as to minimize a total purchase cost of electricity from the first power system and the second power system during a predetermined period.

15. The information processing apparatus according to claim 13, wherein the controller is configured to determine the recommended values of the supply amount, the supply timing, and the unit price of the hydrogen so as to reduce a cost for procuring electricity to supply to the managed area and to increase profit on a sale of hydrogen produced by the hydrogen production facility.

16. The information processing apparatus according to claim 13, wherein the controller is configured to determine the recommended values of the supply amount, the supply timing, and the unit price of the hydrogen using, as a constraint, a hydrogen supply capacity of a hydrogen supply line that supplies hydrogen from the hydrogen production facility that is managed by the second energy management system to the energy resource in the managed area that is managed by the first energy management system.

17. An energy trading system comprising:
an information processing apparatus;
a first energy management system configured to manage an energy resource in a managed area and transmit first information including planned values of a hydrogen purchase amount and a hydrogen purchase unit price to the information processing apparatus; and
a second energy management system configured to manage a hydrogen production facility and transmit second information including planned values of a hydrogen sale amount and a hydrogen sale unit price to the information processing apparatus, wherein
the information processing apparatus is configured to determine a supply amount of hydrogen to be supplied from the hydrogen production facility to the energy resource based on the first information and the second information.

18. The energy trading system according to claim 17, wherein the first information is data in a matrix format that includes respective planned values of a purchase amount, a purchase timing, and a purchase unit price of hydrogen as elements, and the second information is data in a matrix format that includes respective planned values of a sale amount, a sale timing, and a sale unit price of hydrogen as elements.

19. The energy trading system according to claim 17, wherein in a case in which the first information and the second information are matching information, the information processing apparatus is configured to determine a supply amount, a supply timing, and a supply price of hydrogen from the hydrogen production facility to the managed area based on the matching information.

20. The energy trading system according to claim 17, wherein after the supply amount of the hydrogen is determined, the information processing apparatus is configured to create an operation plan for a fuel cell that is included in the energy resource managed by the first energy management system and generates electricity by receiving supply of the hydrogen and transmit the operation plan to the first energy management system, the operation plan including an electricity generation amount and an operating time of the fuel cell.
